(19) United States
(12) Patent Application Publication
(10) Pub. No.: US 2014/0307212 A1
(43) Pub. Date: Oct. 16, 2014

(54) LIQUID CRYSTAL DISPLAY DEVICE

(71) Applicant: Japan Display Inc., Tokyo (JP)

(72) Inventors: Shinichiro OKA, Tokyo (JP); Mika OIWA, Tokyo (JP); Yasushi TOMIOKA, Tokyo (JP); Toshiharu MATSUSHIMA, Tokyo (JP)

(73) Assignee: Japan Display Inc., Tokyo (JP)

(21) Appl. No.: 14/249,493

(22) Filed: Apr. 10, 2014

(30) Foreign Application Priority Data
Apr. 12, 2013 (JP) 2013-084084

(51) Int. Cl. G02F 1/1337

(52) U.S. Cl. CPC G02F 1/1337
USPC 349/123

(57) ABSTRACT

A pixel electrode formed into a slit structure with striped electrodes opposed to each other for a zero rubbing angle can provide fast response since rotational directions of the liquid crystals become opposite at both sides of the slit in the striped electrodes. The electrode structure, however, poses a problem of low transmittance.

Provided is a liquid crystal display device of IPS-Pro scheme including a pixel electrode with one pair of striped electrodes, an electrode section of one of striped electrodes being partially interposed between electrode sections of other striped electrode, and liquid crystals being oriented in a lengthwise direction of the striped electrodes.

### CLAIM OF PRIORITY

The present application claims priority from Japanese patent application JP2013-084084 filed on Apr. 12, 2013, the content of which is hereby incorporated by reference into this application.

### BACKGROUND

The present disclosure relates to a liquid crystal display device, which can be applied to a fast-response liquid crystal display mode, for example.

Liquid crystal display devices are the displays of a non-light-emitting type that display images by controlling the amount of light transmitted from a light source. Liquid crystal displays (LCDs) feature thin-walled and lightweight properties and low power consumption. In-Plane Switching (IPS) is among the typical liquid crystal display schemes currently useable to attain a wide viewing angle. The IPS scheme is a liquid crystal driving scheme that rotates liquid crystal molecules in a planar direction via a horizontal (in-plane) electric field, thus rotates an effective optical axis within a plane, and controls transmittance of the light. Various methods have heretofore been proposed for applying the horizontal electric field. The most common method is by forming a pixel electrode and a common electrode on one substrate with a stripe electrode structure. The application of the horizontal electric field with the stripe electrode structure is accomplished by, for example, forming both of the pixel electrode and the common electrode into the stripe electrode structure, or forming only the pixel electrode into the stripe electrode structure and disposing the common electrode of a flat shape via an insulating layer. Among the methods for applying the electric field are, for example, IPS-Pro (Provectus), which is described in JP-A-2009-150945, and Fringe Field Switching (FFS), which is described in JP-A-2010-19873.

### SUMMARY

The present inventors initially considered adopting a fast-response liquid crystal display mode in the IPS-Pro scheme. The inventors, however, found the following problem:

Forming a pixel electrode into a slit structure including striped electrodes opposed to each other for a zero rubbing angle enables fast response since rotational directions of the liquid crystals become opposite at both sides of the slit in the striped electrodes. The electrode structure, however, poses a problem of low transmittance.

Some of typical features and characteristics of the present disclosure are outlined below.

The pixel electrode of a liquid crystal display device includes one pair of striped electrodes, with an electrode section of one of the striped electrodes being partially interposed between electrode sections of the other striped electrode, and with the liquid crystals being oriented in a lengthwise direction of the striped electrodes.

The liquid crystal display device has fast response characteristics, and yet it can raise transmittance.

### BRIEF DESCRIPTION OF THE DRAWINGS

FIG. 1 is a sectional view of a general IPS-Pro structure in a liquid crystal display device;

FIG. 2 is a plan view of a pixel structure of a liquid crystal display device according to a comparative example;

FIG. 3A is a sectional view of an electrode structure of the liquid crystal display device according to the comparative example, and FIG. 3B is a plan view of the electrode structure;

FIGS. 4A and 4B are explanatory diagrams illustrating the operating principle of the liquid crystal display device according to the comparative example;

FIG. 5 is an explanatory diagram illustrating how the liquid crystal display device according to the comparative example reduces transmittance;

FIG. 6 is a diagram showing an electrode structure of a liquid crystal display device according to an example;

FIG. 7A is a diagram that shows directions of an electric field in the electrode structure of the liquid crystal display device according to the example, and FIG. 7B is a diagram that shows places in which a disclination occurs;

FIGS. 8A and 8B are diagrams that show simulation results on electro-optic response of a conventional liquid crystal display device of the IPS-Pro scheme and the liquid crystal display device according to the example;

FIG. 9 is a diagram that shows measurement results on voltage-luminance characteristics of the electrode structure of the liquid crystal display device according to the comparative example, and those of the electrode structure of the liquid crystal display device according to the example;

FIGS. 10A and 10B are diagrams showing an electrode structure of a liquid crystal display device according to a first modification; and

FIGS. 11A and 11B are diagrams showing an electrode structure of a liquid crystal display device according to a second modification.

### DESCRIPTION OF THE PREFERRED EMBODIMENTS

Hereunder, an example and modifications of the present embodiment, and a comparative example will be described in detail, pursuant to the accompanying drawings. In all of the drawings illustrating the example, the modifications, and the comparative example, elements having the same function are each assigned the same reference number, and repeated description of these elements is omitted hereinafter.

While alignment of liquid crystals (initial alignment of the liquid crystals) is obtained by a rubbing method in the following description, photo-alignment or any other appropriate alignment method may be used instead.

Prior to the present disclosure, the present inventors initially considered adopting the fast-response liquid crystal display mode in the IPS-Pro scheme. The inventors, however, found a problem. The following describes the problem.

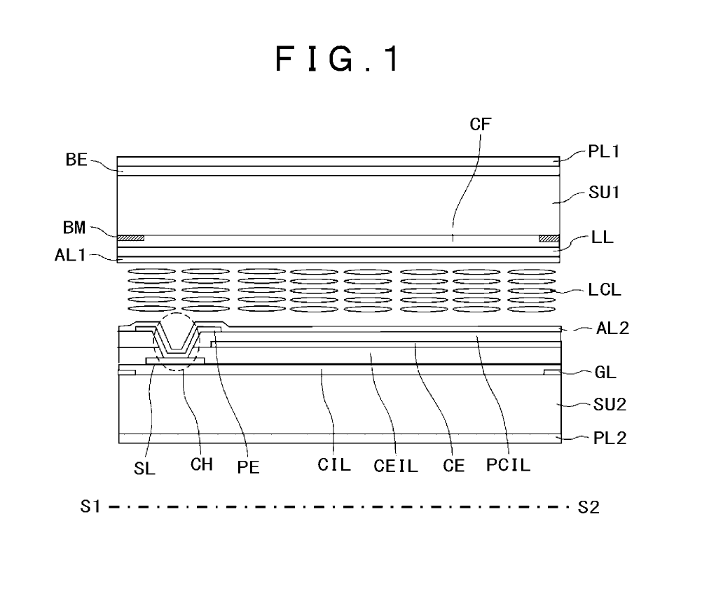

First, a liquid crystal display device of a general IPS-Pro structure is described here. FIG. 1 shows schematically a section of one pixel in the liquid crystal display device of the general IPS-Pro structure. The liquid crystal display device is constituted mainly by a first substrate SU1, a second substrate SU2, and a liquid crystal layer LCL. The first substrate SU1 and the second substrate SU2 hold the liquid crystal layer LCL sandwiched between both. In order to stabilize an aligned state of the liquid crystal layer LCL, the first substrate SU1 and the second substrate SU2 include a first alignment film AL1 and a second alignment film AL2, respectively, on surfaces close to the liquid crystal layer LCL. Means for applying a voltage to the liquid crystal layer LCL is also present on a surface of the second substrate SU2 that is close to the liquid crystal layer LCL. A first polarizer PL1 is mounted above the first substrate SU1, and a second polarizer PL2 above the second substrate SU2.

The first substrate SU1 is a glass substrate. A first alignment film AL1, a leveling layer LL, a color filter CF, and a black matrix BM are stacked in that order between the first substrate SU1 and the liquid crystal layer LCL. The first alignment film AL1 is a polyimide-containing organic high-polymer film and is a horizontal alignment film. The leveling layer LL is an acrylic resin, excels in transparency, and has a function that levels out surface irregularities of an underlayer and prevents penetration of a solvent. The color filter CF has a flat structure with a repeated array of striped elements assuming red, green, and blue colors. The black matrix is formed from a resist including a black pigment, and has a planarly distributed structure of a grid-like shape, geared to identify pixel boundaries. In addition, a backside electrode BE for antistatic purposes is disposed on a side of the first substrate SU1 that is opposite to a side on which the liquid crystal layer LCL is disposed. The backside electrode BE is made from an indium-tin oxide (ITO) that exhibits a planar distribution of a flat form.

The second substrate SU2 is a glass substrate, as with the first substrate SU1. A second alignment film AL2, a pixel electrode PE, an interlayer insulating film PCIL, a common electrode CE, an active element (not shown), a gate line GL, and a source line SL are main elements provided between the second substrate SU2 and the liquid crystal layer LCL. The second alignment film AL2, as with the first alignment film AL1, is a horizontal alignment film formed from a polyimide-containing organic high-polymer film. The pixel electrode PE and the common electrode CE are both made from an ITO that excels in transparency and electric conduction properties. Both PE and CE are separated from each other by the interlayer insulating film PCIL made of silicon nitride (SiN). Whereas the pixel electrode PE is striped in flat shape, the common electrode CE has a contact hole CH, but is distributed over a substantially entire pixel surface. A gate line insulating film GIL is disposed on the gate line GL, a source line SE on the gate line insulating film GIL, and a common electrode insulating film CEIL on the gate line insulating film GIL and the source line SE.

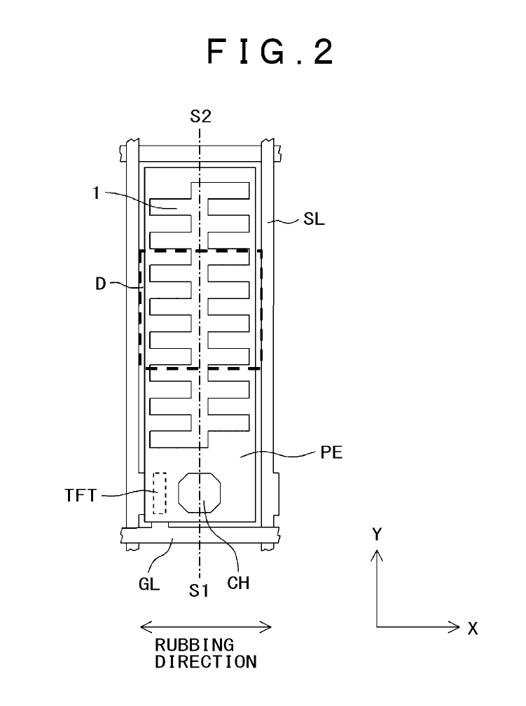

Since the pixel electrode structure in FIG. 1 is most important in the present disclosure, only the pixel electrode PE, the interlayer insulating film PCIL, and the common electrode CE will be described hereinafter. The pixel electrode shape and liquid crystal alignment direction of the liquid crystal display device in the IPS-Pro structure (comparative example) whose adoption was considered prior to the present disclosure, and those of the liquid crystal display device of the example differ from the pixel electrode shape and liquid crystal alignment direction of the liquid crystal display device, shown in FIG. 1. In other structural aspects, however, the former two liquid crystal display devices are substantially the same as in FIG. 1. While FIG. 1 corresponds to an S1-S2 section in FIG. 2, the shape of the pixel electrode and the direction in which the liquid crystals are aligned differ from those of FIG. 2.

FIG. 2 is a plan view of a pixel structure of the liquid crystal display device according to the comparative example. As shown in FIG. 2, the pixel electrode PE is rectangular in flat shape and has a slit 1 and a contact hole CH. The pixel electrode PE constitutes one pair of striped electrode sections with the slit 1. The striped electrode sections of the pixel electrode PE are formed so that a lengthwise direction of each is parallel to an X-direction in which a gate line GL extends. In addition, the left-and-right pair of striped electrode sections are formed to be shifted in position from each other by substantially half a pitch in FIG. 2. The common electrode CE, which is present at a position lower than that of the pixel electrode PE, has a contact hole CH not shown, but is distributed over a substantially entire pixel surface. Outside the pixel electrode PE, a source line SL extends in a longitudinal direction (Y-direction) of the electrode PE. In addition, outside the pixel electrode PE, a gate line GL extends in a lateral direction (X-direction) of the electrode PE. A thin-film transistor TFT as an active element, is present at a position lower than that of the common electrode CE.

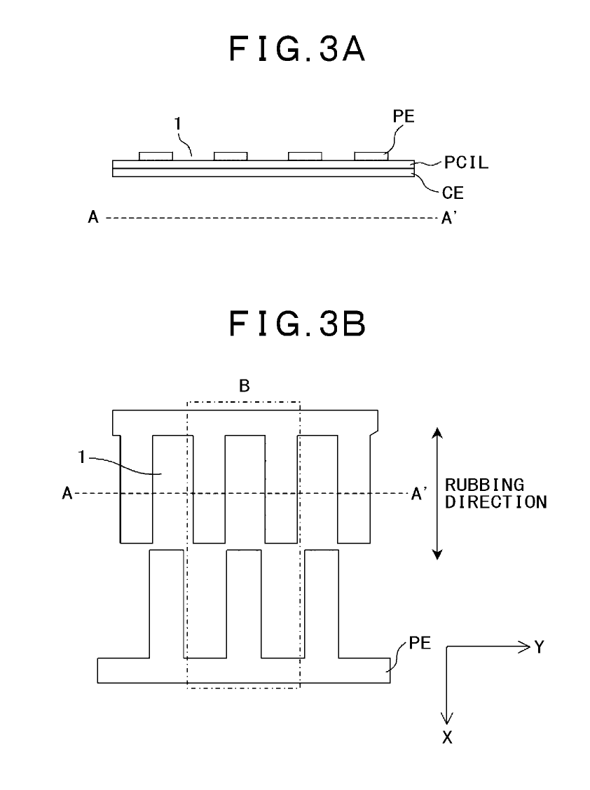

FIGS. 3A and 3B are enlarged views of a region D in the electrode structure of FIG. 2. FIG. 3A is a sectional view of an A-A′ line in FIG. 3B, and FIG. 3B is a plan view. The pixel electrode PE is disposed above the common electrode CE via an interlayer insulating film PCIL. A rubbing direction, which is a liquid crystal alignment direction, is parallel to the lengthwise direction of the striped electrode sections of the pixel electrode PE. The pair of upper and lower striped electrode sections are formed to be shifted in position from each other by substantially half a pitch in FIG. 3B. A line connecting a distal end of each upper striped electrode section is separate from a line connecting a distal end of each lower striped electrode section.

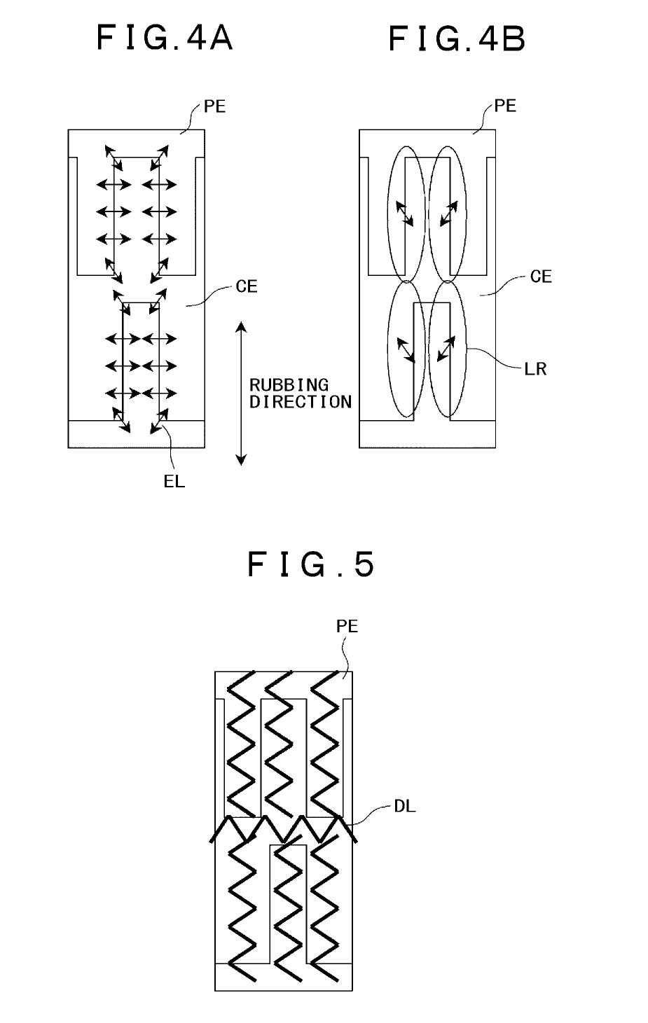

FIGS. 4A and 4B are explanatory diagrams illustrating the way the liquid crystal display device according to the comparative example operates. FIGS. 4A and 4B are drawings showing only a region B of FIG. 3B. FIG. 4A shows directions of an electric field, and FIG. 4B shows rotational directions of the liquid crystals. The rubbing direction, or the alignment direction of the liquid crystals, is parallel to the lengthwise direction of the striped electrode sections of the pixel electrode PE, and the liquid crystal is made of a material that has a positive dielectric anisotropy. Thus, the liquid crystals between the striped electrode sections have equal force for clockwise and counterclockwise rotation, so that the respective rotational directions are not determinate. As indicated by the direction EL of the electric field in FIG. 4A, therefore, the electric field at edges or bases of the striped electrode sections is rendered oblique with respect to the electrode. As indicated by the rotational direction LR of the liquid crystals in FIG. 4B, the directions in which the liquid crystals rotate are determined based on the oblique field. Thus, the liquid crystals rotate in two different directions between the striped electrodes At this time, regions in which the liquid crystals rotate in the same direction become small, compared with those of the conventional IPS-Pro or FFS schemes, and consequently, the aligned liquid crystals are significantly distorted, increase in resilience, and can be driven at a higher speed.

FIG. 5 is an explanatory drawing that illustrates how the liquid crystal display device according to the comparative example reduces transmittance. In a case that the liquid crystals differ in rotational direction, disclinations occur at the boundaries. In the electrode structure based on the IPS-Pro technology whose adoption was considered prior to the present disclosure, disclination lines DL, denote generation of black lines, ought to occur during voltage application, as shown in FIG. 5. Sufficient transmittance cannot be obtained at where the disclination lines DL occur.

The liquid crystal display device according to the comparative example, therefore, poses a problem that while fast response can be obtained, transmittance is low.

To deal with the above problem, the structure of the pixel electrode was studied. A liquid crystal display device according to an embodiment includes a common electrode having a structure of a flat shape, and pixel electrode. The pixel electrode includes one pair of striped electrodes, with an electrode section of one of the striped electrodes being partially interposed between electrode sections of the other striped electrode, and with liquid crystals being initially oriented in a lengthwise direction of the striped electrodes. The liquid crystal display device according to the embodiment has fast response characteristics, and yet the device can raise transmittance. Hereunder, the embodiment will be described in detail using an example.

### Example

As described above, the pixel electrode shape and liquid crystal alignment direction of the liquid crystal display device according to the example differ from those of the liquid crystal display device, shown in FIG. 1. In terms of other structural aspects, however, the liquid crystal display device of the example is substantially the same as in FIG. 1.

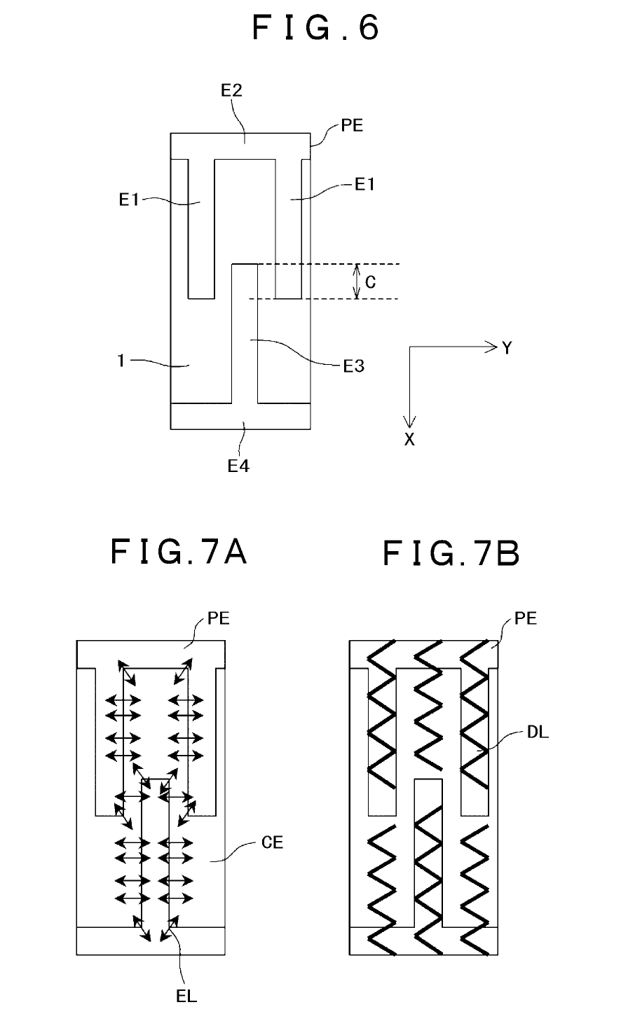

FIG. 6 is an external view showing an electrode structure of the liquid crystal display device according to the example. As shown in FIG. 6, although one pair of striped electrodes are shifted in position from each other by half a pitch, the two striped electrodes extend to a distal end of each other and form a nested structure. In other words, an electrode section of one of the striped electrodes is partially interposed between electrode sections of the other striped electrode. For left-right balancing, the pair of striped electrodes are preferably shifted in position from each other by exactly half a pitch, but do not always need to be shifted by exactly half a pitch. It is vital that the pair of striped electrodes be disposed to form a nested structure, and the striped electrodes can exist within a pixel region of at least one pair. The flat structure of the pixel electrode PE is described in further detail below.

One of the pair of striped electrodes, that is, a first striped electrode includes a plurality of first electrode sections E1 each extending in an X-direction, and a second electrode section E2 connecting ends of the first electrode sections E1 and extending in a Y-direction. The other striped electrode, that is, a second striped electrode includes a plurality of third electrode sections E3 each extending in the X-direction, and a fourth electrode section E4 connecting ends of the third electrode sections E3 and extending in the Y-direction. The first electrode sections E1 and the third electrode sections E3 are each of a rectangular shape. The first electrode sections E1 and the third electrode sections E3 are placed between the second electrode section E2 and the fourth electrode section E4. The other end (distal end) of each of the first electrodes faces the fourth electrode, and the other end (distal end) of each of the third electrodes faces the second electrode. One first electrode E1 and one third electrode E3 are disposed at alternate positions. The distal end of the first electrode E1 is sandwiched between the third adjacent electrode sections E3. The distal end of the third electrode E3 is sandwiched between the first adjacent electrode sections E1. The pixel electrode PE of the rectangular shape is formed with a slit to constitute the pair of striped electrodes, as so done in the comparative example. The first electrode sections E1 and the third electrode sections E3 need only to extend in the same direction and do not always need to extend exactly in the X-direction.

In the comparative example, the liquid crystals between the pair of striped electrodes cannot move. In the present example, however, the pixel electrode structure enables the liquid crystals between the pair of striped electrodes to move, which improves transmittance. An advantageous effect can be obtained if nesting length C exceeds 0. The nested structure can be obtained by either extending a spacing between the striped electrodes or narrowing down width thereof, relative to those of the comparative example.

Except for shape, the striped electrode sections of the pixel electrode PE are substantially the same as those of the structure in the comparative example. More specifically, except for shape, the striped electrode sections in FIGS. 2, 3A, 3B are substantially of the same pixel structure as in the example. A rubbing direction, or the direction in which the liquid crystals are aligned, is parallel to a lengthwise direction of the striped electrode sections of the pixel electrode PE, as in the comparative example. The striped electrode sections of the pixel electrode PE are formed so that the lengthwise direction (X-direction) of each is parallel to the X-direction in which a gate line GL extends. The lengthwise direction (X-direction) of each striped electrode section of the pixel electrode PE, however, needs only to be parallel to each other and does not always need to be parallel to the X-direction in which the gate line GL extends.

FIGS. 7A and 7B are drawings that show directions of an electric field, and places in which a disclination occurs, in the electrode structure of the liquid crystal display device according to the example. FIG. 7A shows the directions of the electric field, and FIG. 7B shows the places in which the disclination occurs. As can be seen by comparing FIGS. 7B and 5, the number of places where the disclination occurs is reduced in the example. Thus, transmittance can be raised.

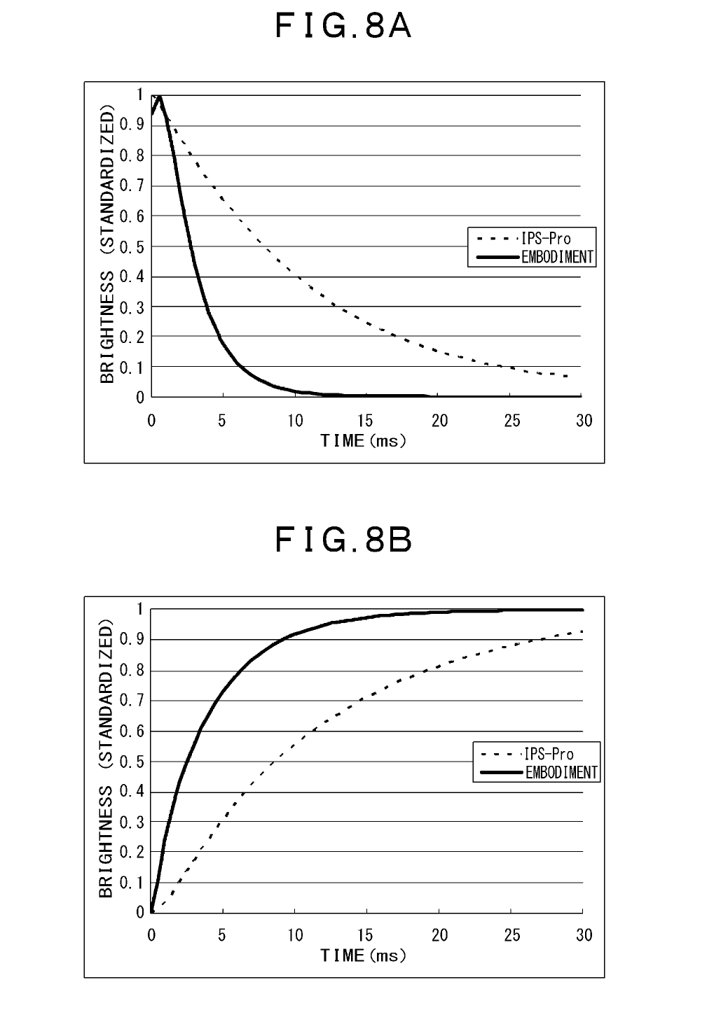

FIGS. 8A and 8B are diagrams that show simulation results on electro-optic response of the conventional liquid crystal display device of the IPS-Pro scheme and the liquid crystal display device according to the example. Both devices are made from liquid crystal materials having the same physical properties. FIG. 8A shows a fall time up to turn-off of the device, and FIG. 8B shows a rise time up to turn-on of the device. As is evident from the simulation results, the electrode structure of the example provides rapid driving of the liquid crystals. More specifically, as shown in FIG. 8A, the conventional IPS-Pro scheme (shown as IPS-Pro in FIGS. 8A and 8B) requires a fall time of about 25 msec at a 100%-10% response signal level, whereas the example requires only a fall time of about 6 msec at the same response signal level as the above. This means that the example implements more rapid driving than the conventional IPS-Pro scheme does. It can also be seen from FIG. 8B that at a 0%-90% response signal level, whereas the conventional IPS-Pro scheme requires a rise time of about 26 msec, the example requires only a rise time of about 10 msec, which means that the example implements more rapid driving than the conventional IPS-Pro scheme does. As in FIG. 4B, the liquid crystals rotate in two different directions between the striped electrodes. Thus, regions in which the liquid crystals rotate in the same direction become small, compared with those of the conventional IPS-Pro or FFS schemes, and consequently, the aligned liquid crystals are significantly distorted, increase in resilience, and can be driven at a higher speed.

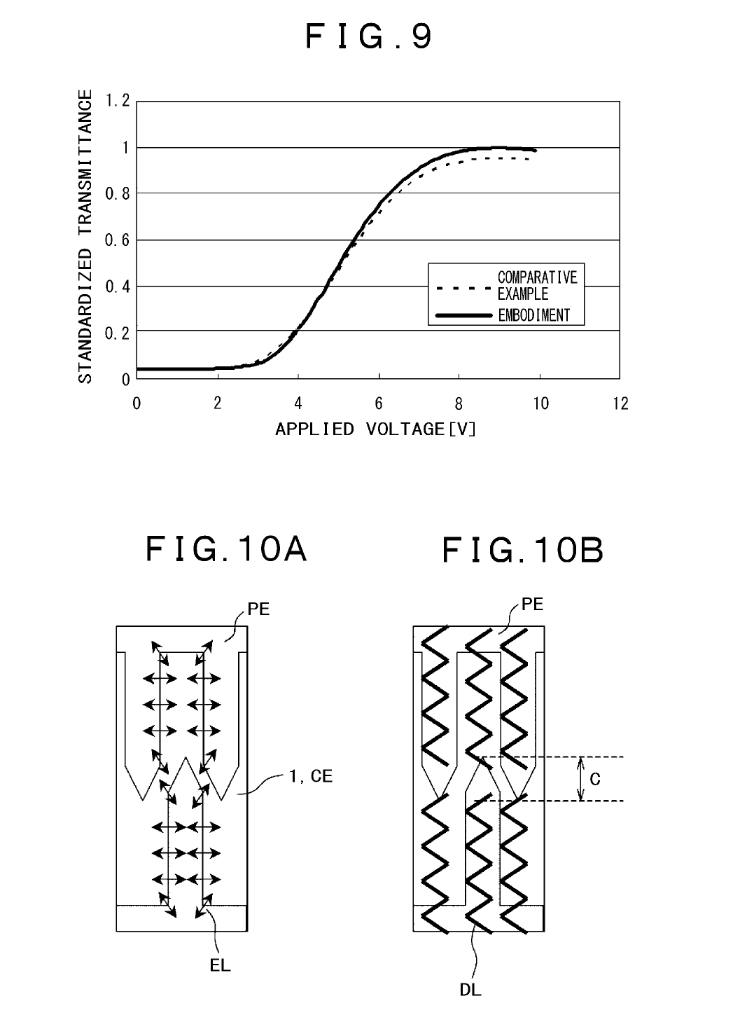

FIG. 9 is a diagram that shows measurement results on voltage-luminance characteristics of a cell with the electrode structure of the liquid crystal display device according to the comparative example, and a cell with the electrode structure of the liquid crystal display device according to the example. FIG. 9 indicates that the electrode structure of the liquid crystal display device according to the example improves luminance by about 5%.

In the liquid crystal display device according to the example, as in the comparative example, rapid driving can be realized since the rotational directions of the liquid crystals become opposite at both sides of the slits in the striped electrodes of the pixel electrode. In other words, rapid driving can be realized since the rotational directions of the liquid crystals become opposite at both slits in the striped electrodes of the pixel electrode. In addition, although the liquid crystals in the comparative example do not move at specific places, the liquid crystals in the example move, which improves transmittance.

Since the liquid crystal display device according to the example can respond rapidly, the display device can be applied as a vehicle-mounted liquid crystal display device. Additionally, since video performance improves, the display device can be applied as a liquid crystal display device for a smartphone or tablet terminal.

### First Modification

FIGS. 10A and 10B are drawings showing an electrode structure of a liquid crystal display device according to a first modification. FIG. 10A shows directions of an electric field, and FIG. 10B shows places in which a disclination occurs. The pixel electrode structure of the liquid crystal display device according to the first modification includes a protruding structure at distal ends of a nested structure, as shown in FIGS. 10A and 10B. The protruding structure is a structure in which the striped electrodes diminish in width as they go toward the respective distal ends, and in FIGS. 10A and 10B, the protruding structure is triangular in shape. As shown in FIG. 10B, no disclinations occur between one pair of striped electrodes, which even further raises transmittance. In the pixel electrode structure of the liquid crystal display device according to the first modification, as shown in FIG. 10B, the electric field at that time in the nested structure continuously changes between the pair of striped electrodes, and these changes suppress the occurrence of a disclination. An advantageous effect can be obtained if nesting length C exceeds 0. In the pixel electrode structure according to the example, as shown in FIG. 7A, the electric field does not continuously change at the distal ends of the striped electrodes. The pixel electrode structure of the liquid crystal display device according to the first modification, therefore, provides higher transmittance than the pixel electrode structure of the liquid crystal display device according to the example.

### Second Modification

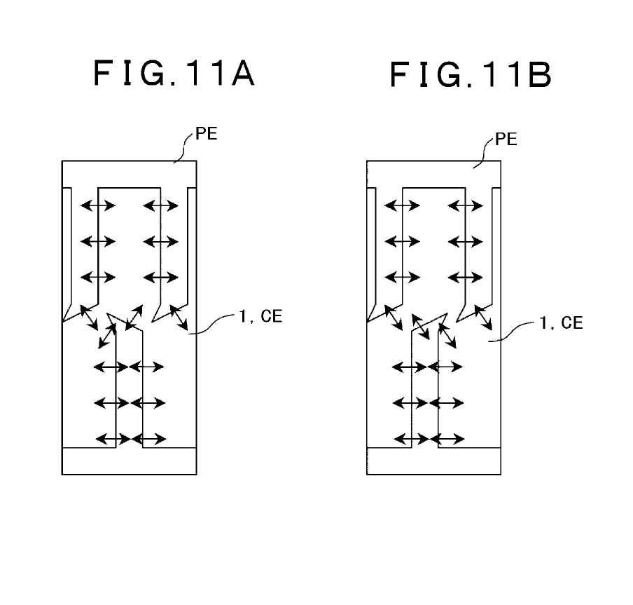

FIGS. 11A and 11B are drawings showing an electrode structure of, and directions of an electric field in, a liquid crystal display device according to a second modification. As shown in FIGS. 11A and 11B, striped electrodes of a nested structure each have a distal end of a protruding structure and the distal end is bent. The protruding structure has a triangular shape, with one corner of the triangle being obtuse in angle. FIG. 11A shows a case in which a first (upper) striped electrode and a second (lower) striped electrode are bent in the same direction at the respective distal ends, and FIG. 11B shows a case in which the first (upper) striped electrode and the second (lower) striped electrode are bent in opposite directions at the respective distal ends. The pixel electrode structure of the liquid crystal display device according to the second modification yields a pinning effect that by virtue of the electrode structure with the bent distal ends, even if disclinations occur between the striped electrodes, this does not affect other regions. The pixel electrode structure in FIG. 11B is more uniform in the directions of the electric field at the electrode distal ends than the pixel electrode structure in FIG. 11 is, so that the pixel electrode structure in FIG. 11B offers a greater pinning effect against disclinations.

While the invention achieved by the present inventors has been described in detail above on the basis of the embodiment, the example, and the modifications, it goes without saying that the invention is not limited to the embodiment, the example, and the modifications, and may be changed or modified in various forms.

What is claimed is:

1. A liquid crystal display device, comprising:
a common electrode of a flat structure;
a pixel electrode disposed above the common electrode via an insulating film;
an alignment film disposed on the pixel electrode; and
a liquid crystal layer disposed on the alignment film, wherein
the pixel electrode includes one pair of striped electrodes,
a protruding electrode section of one of the pair of striped electrodes is partially interposed between protruding electrode sections of the other striped electrode, and
liquid crystals are aligned in a lengthwise direction of the protruding electrode sections of the pair of striped electrodes.

2. The liquid crystal display device according to claim 1, wherein the pixel electrode constitutes the pair of striped electrode sections with a slit.

3. The liquid crystal display device according to claim 1, wherein
the pixel electrode includes a contact hole in a place different from where the slit is located,
the common electrode includes a hole, and
the hole is close to the contact hole.

4. The liquid crystal display device according to claim 1, further comprising a gate line, wherein the lengthwise direction of the protruding electrode sections of the pair of striped electrodes is parallel to a direction in which the gate line extends.

5. The liquid crystal display device according to claim 1, further comprising a source line, wherein the lengthwise direction of the protruding electrode sections of the pair of striped electrodes is orthogonal to a direction in which the source line extends.

6. The liquid crystal display device according to claim 1, wherein the liquid crystal layer is made from a material that has a positive dielectric anisotropy.

7. The liquid crystal display device according to claim 1, wherein the protruding electrode sections of the pair of striped electrodes each include a sharp distal end.

8. The liquid crystal display device according to claim 7, wherein the protruding electrode sections of the pair of striped electrodes are each bent at the sharp distal end.

9. A liquid crystal display device, comprising:
a common electrode of a flat structure;
a pixel electrode disposed above the common electrode via an insulating film;
an alignment film disposed on the pixel electrode; and
a liquid crystal layer disposed on the alignment film, wherein
the pixel electrode includes a first striped electrode and a second striped electrode,
the first striped electrode has a plurality of first electrode sections and a second electrode section, the first electrode sections extending in a first direction, the second electrode extending in a second direction and connecting ends of the first electrode sections,
the second striped electrode has a plurality of third electrode sections and a fourth electrode section, the third electrode sections extending in the first direction, the fourth electrode section extending in the second direction and connecting ends of the third electrode sections,
the each first electrode has a distal end sandwiched between the third adjacent electrode sections,
the each third electrode has a distal end sandwiched between the first adjacent electrode sections, and
liquid crystals are aligned in a first direction.

10. The liquid crystal display device according to claim 9, wherein the first direction is orthogonal to the second direction.

11. The liquid crystal display device according to claim 9, wherein the pixel electrode constitutes the first striped electrode and the second striped electrode with a slit.

12. The liquid crystal display device according to claim 9, wherein
the pixel electrode includes a contact hole in a place different from where the slit is located,
the common electrode includes a hole, and
the hole is close to the contact hole.

13. The liquid crystal display device according to claim 9, further comprising a gate line extended in the first direction.

14. The liquid crystal display device according to claim 9, further comprising a source line extended in the second direction.

15. The liquid crystal display device according to claim 9, wherein the liquid crystal layer is made from a material that has a positive dielectric anisotropy.
